(19) United States
(12) Patent Application Publication
(10) Pub. No.: US 2015/0199567 A1
(43) Pub. Date: Jul. 16, 2015

(54) DOCUMENT CLASSIFICATION ASSISTING APPARATUS, METHOD AND PROGRAM

(71) Applicant: KABUSHIKI KAISHA TOSHIBA, Tokyo (JP)

(72) Inventors: Kosei Fume, Kawasaki Kanagawa (JP); Masaru Suzuki, Kawasaki Kanagawa (JP); Kenta Cho, Kawasaki Kanagawa (JP); Masayuki Okamoto, Kawasaki Kanagawa (JP)

(21) Appl. No.: 14/668,638

(22) Filed: Mar. 25, 2015

Related U.S. Application Data
(63) Continuation of application No. PCT/JP2013/075607, filed on Sep. 17, 2013.

(30) Foreign Application Priority Data
Sep. 25, 2012 (JP) 2012-210988

(51) Int. Cl. G06K 9/00; G06K 9/46; G06K 9/62; G06K 9/18

(52) U.S. Cl. CPC G06K 9/00442; G06K 9/18; G06K 9/4604; G06K 9/6267

(57) ABSTRACT

According to one embodiment, a document classification assisting apparatus includes an input unit, an extracting unit, an amount calculator, a setting unit, a calculator, and a storage. The input unit inputs documents including stroke information. The extracting unit extracts, from the stroke information, at least one of figure, annotation and text information. The amount calculator calculates, from the information extracted, feature amounts that enable comparison in similarity between the documents. The setting unit sets clusters including representative vectors that indicate features of the clusters and each include the feature amounts, and detects to which one of the clusters each of the documents belongs. The calculator calculates, as a classification rule, at least one of the feature amounts included in the representative vectors and characterizing the representative vectors. The storage stores the classification rule.

### CROSS-REFERENCE TO RELATED APPLICATIONS

This application is a Continuation application of PCT Application No. PCT/JP2013/075607, filed Sep. 17, 2013 and based upon and claims the benefit of priority from Japanese Patent Application No. 2012-210988, filed Sep. 25, 2012, the entire contents of all of which are incorporated herein by reference.

### FIELD

Embodiments described herein relate generally to a document classification assisting apparatus, method and program associated with handwritten documents.

### BACKGROUND

Tablet type terminals have recently come into wide use. In accordance with this, pen input devices as input devices have come to draw attention. Once such an environment is fixed up, users can easily create documents at any time, using an input device that is an intuitive device obtained by simulating paper and a pen to which the users are familiar. However, unlike the conventional text data, it is not easy to search for the thus-created document or reuse the same by, for example, copy and paste.

In particular, since information is stored as handwriting data (stroke data), full-text searching, for example, utilized in the case of text documents cannot be used. Further, even if a stroke recognition technique is applied, errors may well exist in text recognition, which makes it difficult to correctly detect the document the user intends to do.

In order to realize document classification under the above circumstances, it has been proposed to detect, in a handwritten document input to a tablet, stroke data indicating the direction and length of a stroke, and/or whether the stroke includes a curve, thereby assigning, utilizing fuzzy analogism, a corresponding keyword (such as “a document using figures as main constituents” and “the writer is a child”) selected from beforehand registered keyword data. This enables document classification to be realized based on document features, without requiring character recognition results from strokes.

However, in such a method as the above, in which determination is performed based on the patterning of beforehand defined stroke length and direction, presence/absence of curves, etc., variations of users' free formats, which were not assumed when the method was designed, cannot be covered. Furthermore, in this method, it is difficult to newly set or add a detailed classification category that meets users' needs.

On the other hand, when the use of a handwritten character recognition result from a stroke is attempted, if a simple clustering method is employed, there is a case where the representative term of each cluster may be hard to understand to the users, since original data contains recognition error text. Yet further, when a general clustering method is employed, classification accuracy cannot be determined in, for example, an initial stage of use, since a large number of documents do not exist in the initial stage.

### BRIEF DESCRIPTION OF THE DRAWINGS

FIG. 1 is a block diagram illustrating a document classification assisting apparatus according to an embodiment;

FIG. 2 is a block diagram illustrating a document classification assisting apparatus according to another embodiment, in which the candidate calculating unit shown in FIG. 1 is replaced with a candidate presenting/selecting unit;

FIG. 3 is a flowchart illustrating an example of an operation performed by the document classification assisting apparatus of FIG. 2 when a rule is constructed;

FIG. 4 is a flowchart illustrating an example of an operation performed by each of the document classification assisting apparatuses of the embodiments when document classification is performed;

FIG. 5 is a flowchart illustrating an example of an operation performed by the figure feature extracting unit shown in FIGS. 1 and 2;

FIG. 6 is a flowchart illustrating an example of an operation performed by the document feature amount extracting/converting unit shown in FIGS. 1 and 2;

FIG. 7 is a flowchart illustrating an example of an operation performed by the similarity detecting unit shown in FIGS. 1 and 2;

FIG. 8 is a view illustrating an example of a definition of similarity between documents;

FIG. 9 is a view illustrating an example of a definition of similarity between figure features;

FIG. 10 is a view illustrating an example of a similarity weight adjusting user interface;

FIG. 11 is a flowchart illustrating an example of an operation performed by the candidate calculating unit of FIG. 1;

FIG. 12 is a flowchart illustrating an example of an operation performed by the candidate presenting/selecting unit of FIG. 2;

FIG. 13 is a view illustrating an example of a presentation screen for presenting a classification candidate in the candidate presenting/selecting unit of FIG. 2; and

FIG. 14 is a flowchart illustrating an example of an operation performed by the classification estimating unit of FIG. 1.

### DETAILED DESCRIPTION

A document classification assisting apparatus, method and program according to embodiments will be described in detail with reference to the accompanying drawings. In the embodiments, like reference numbers denote like elements, and duplication of description will be avoided.

The embodiments have been developed in light of the above-mentioned circumstances, and aims to provide document classification assisting apparatuses, method and program for assisting automatic classification of handwritten documents.

In general, according to one embodiment, a document classification assisting apparatus includes a document input unit, an extracting unit, a feature amount calculator, a setting unit, a calculator, and a storage. The document input unit inputs documents including stroke information. The extracting unit extracts, from the stroke information, at least one of figure information, annotation information and text information. The feature amount calculator calculates, from the information extracted, feature amounts that enable comparison in similarity between the documents. The setting unit sets clusters including representative vectors that indicate features of the clusters and each include the feature amounts, and detects to which one of the clusters each of the documents belongs. The calculator calculates, as a classification rule, at least one of the feature amounts included in the representative vectors and characterizing the representative vectors. The storage stores the classification rule.

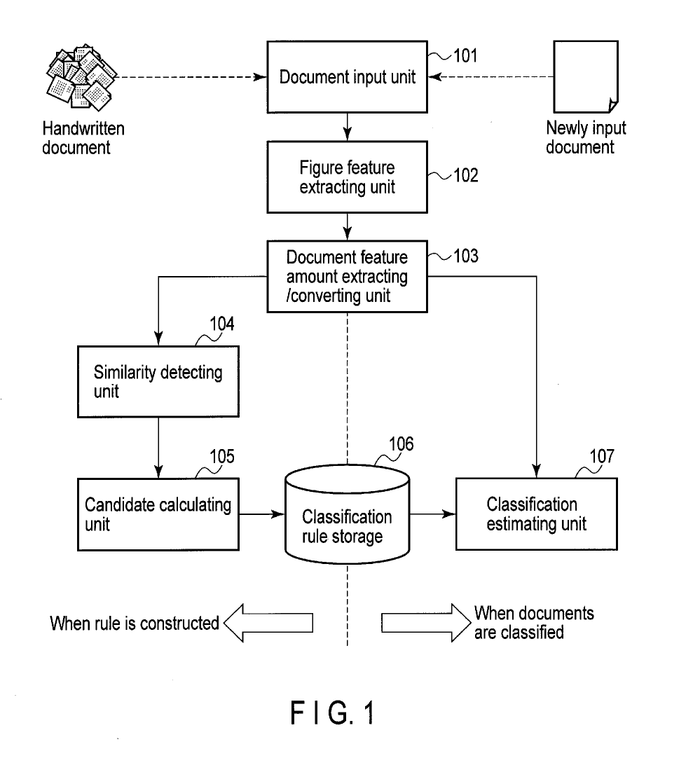

Referring first to FIG. 1, a document classification assisting apparatus according to an embodiment will be described.

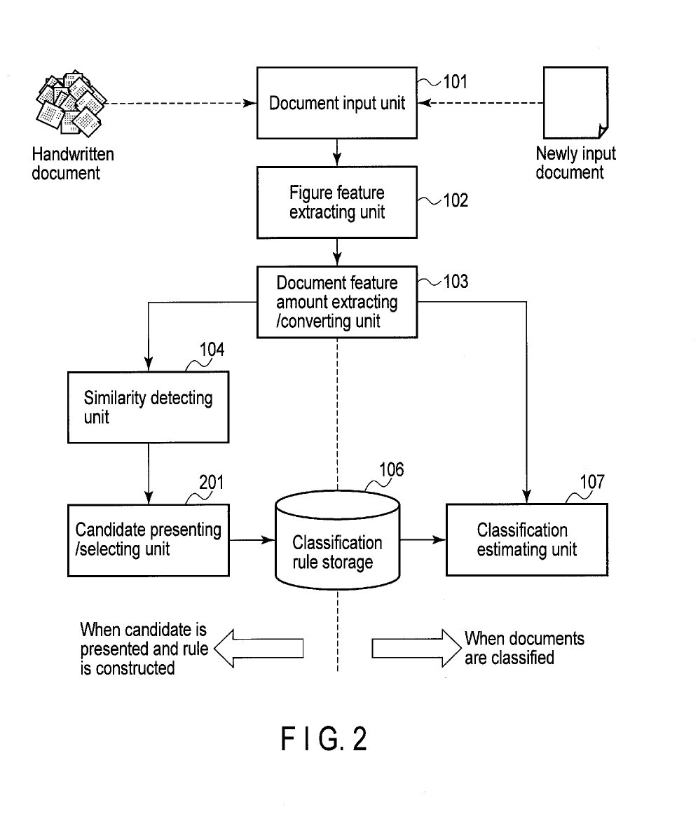

The document classification assisting apparatus of the embodiment comprises a document input unit 101, a figure feature extracting unit 102, a document feature amount extracting/converting unit 103, a similarity detecting unit 104, a candidate calculating unit 105, a classification rule storage 106 and a classification estimating unit 107. The document classification assisting apparatus is used to (1) construct a rule, and to (2) input a new document to classify this document. When performing construction (1), the document input unit 101, the figure feature extracting unit 102, the document feature amount extracting/converting unit 103, the similarity detecting unit 104, the candidate calculating unit 105, and the classification rule storage 106 are used. When (2) inputting a new document to classify the document, the document input unit 101, the figure feature extracting unit 102, the document feature amount extracting/converting unit 103, the classification rule storage 106, and the classification estimating unit 107 are used. There is a case where (3) a candidate is presented to a user for rule construction, instead of the rule construction (1). This will be described later with reference to FIG. 2.

The document input unit 101 inputs a handwritten document. In the above-mentioned case (1) or (3), the document input unit 101 inputs a handwritten document set (e.g., a set of user created documents) comprising a large number of handwritten documents accumulated for learning. In the above-mentioned case (2), the document input unit 101 inputs a new document to be classified. In this description, the new document is not a text document but a set of handwriting data (stroke data), i.e., stroke information.

The figure feature extracting unit 102 is used in any of the cases (1) to (3). The figure feature extracting unit 102 extracts a figure feature amount or a character recognition result from the document input by the document input unit 101. The character recognition result includes annotation information and text character string. The annotation information is associated with, for example, annotation symbols, such as double lines and enclosures. The figure feature extracting unit 102 makes the extracted figure feature amount and character recognition result correspond to the document (or the corresponding page in the document). The figure feature extracting unit 102 detects whether each document contains a figure or table, and extracts various annotation symbols (such as double lines and enclosures), character strings, words, etc.

The document feature amount extracting/converting unit 103 is used in any of the above-mentioned cases (1) to (3) to calculate a feature amount for enabling a comparison between the degrees of similarity of documents, based on the information extracted by the figure feature extracting unit 102. The document feature amount extracting/converting unit 103 converts the extraction results so far into comparable feature amounts. For instance, the document feature amount extracting/converting unit 103 extracts a logical element (such as an element associated with the layout of each document) from each text area, and converts, into feature amounts that can be easily compared with each other, the document feature amount extracted by the figure feature extracting unit 102 from the character recognition result, and the figure feature amount extracted by the figure feature extracting unit 102. The document feature amount extracting/converting unit 103 performs conversion to, for example, document vectors.

The similarity detecting unit 104 functions only in the above-mentioned case (1) or (3) to calculate the degrees of similarity of documents based on a plurality of feature amounts corresponding to a great amount of documents and obtained by the conversion by the document feature amount extracting/converting unit 103. The similarity detecting unit 104 calculates the degrees of similarity using all feature amounts extracted so far.

The candidate calculating unit 105 functions only in the above-mentioned case (1) to calculate classification candidates of highest ranks from the grouping result that is based on the degrees of similarity obtained by the similarity detecting unit 104. The candidate calculating unit 105 determines the candidates of the highest ranks as members of a classification rule, and stores them in a classification rule storage 106. The classification rule indicates the relationship between the selected candidates. For instance, the classification rule indicates the relationship between feature amounts and the corresponding comparable numerical values.

In the case (1) or (3), the classification rule storage 106 stores a combination of classification conditions as the classification rule. In the case (2), the classification rule storage 106 is referred to by the classification estimating unit 107.

The classification estimating unit 107 functions only in the case (2) to compare the converted feature amount with the classification rule stored in the classification rule storage 107. Based on the comparison result, the classification estimating unit 107 classifies each new document into a predetermined category.

Referring now to FIG. 2, a description will be given of an example case where the candidate calculating unit 105 of the document classification assisting apparatus shown in FIG. 1 is replaced with a candidate presenting/selecting unit 201. FIG. 2 is a block diagram illustrating the case (3) where candidates are presented to a user to construct a rule, instead of the case (1).

The candidate presenting/selecting unit 201 presents classification candidates determined from the result of grouping performed based on the degrees of similarity obtained by the similarity detecting unit 104. Referring to the presented classification candidates, the user determines the classification rule, and the candidate presenting/selecting unit 201 stores the determined classification rule in the classification rule storage 106.

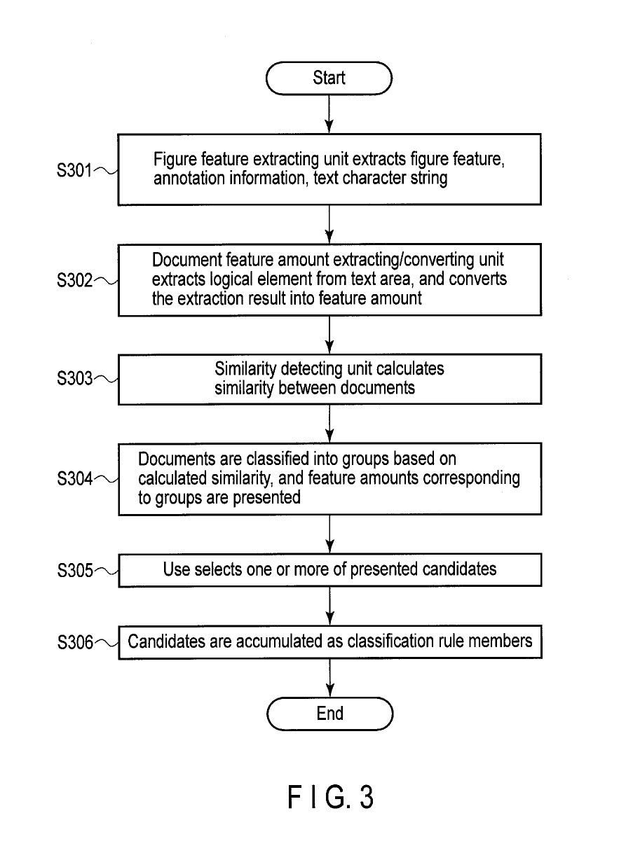

Referring then to FIG. 3, a description will be given of an example of an operation performed by the document classification assisting apparatus in the case (3) where candidate presentation is performed for rule construction.

Firstly, the document input unit 101 inputs a handwritten document set. The figure feature extracting unit 102 extracts, from each document, a figure feature amount, annotation information and a text character string (step S301).

The document feature amount extracting/converting unit 103 extracts a logical element from each text area of said each document, and converts each extraction result into a feature amount (step S302).

The similarity detecting unit 104 calculates the similarity (more specifically, the degrees of similarity) between all documents (step S303).

Based on the calculated degrees of similarity, the candidate presenting/selecting unit 201 classifies the documents into groups and presents feature amounts as clues to the classification (step S304).

Subsequently, the candidate presenting/selecting unit 201 permits the user to select at least one of the presented candidates (step S305). The thus-selected candidates (usually, a plurality of candidates) are accumulated as classification rule members in the classification rule storage 106, and a classification rule indicating the relationship between the candidates is also accumulated in the storage 106 (step S306).

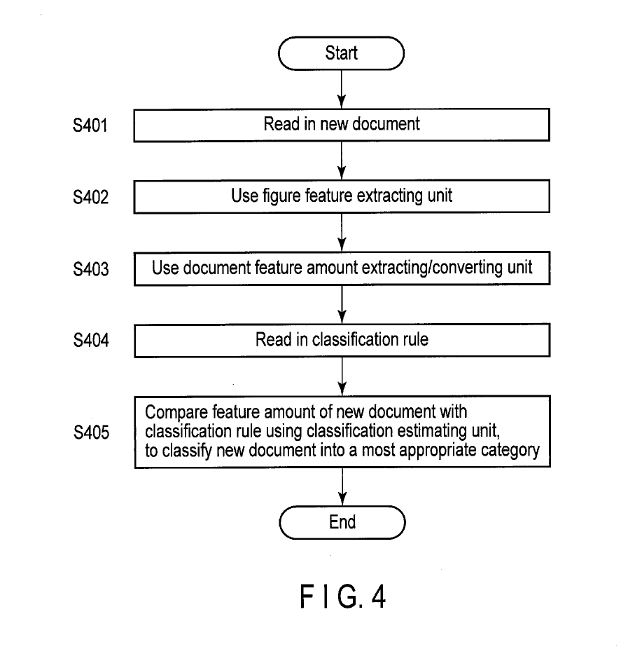

Referring then to FIG. 4, a description will be given of an example of an operation performed in the document classification case (2).

Firstly, the document input unit 101 reads in a new document as a new classification target (step S401).

The figure feature extracting unit 102 extracts, from the new document, a figure feature amount, annotation information and a text character string (step S402).

The figure feature amount extracting/converting unit 103 extracts a logical element from the text area of the new document, and converts each extraction result, which includes the logical element of each document and is obtained so far, into a feature amount that can be subjected to similarity degree calculation (step S403).

The similarity estimating unit 107 reads a classification rule from the classification rule storage 106 (step S404), and then compares the feature amount of the new document as a classification target with the classification rule, thereby classifying the new document into a most appropriate category (step S405).

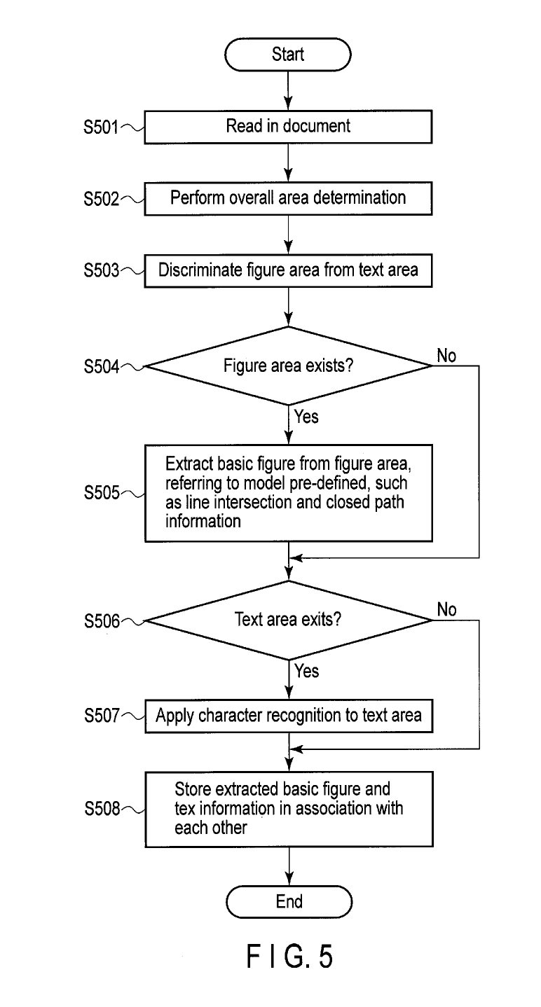

Referring further to FIG. 5, an example of an operation performed by the figure feature extracting unit 102 will be described.

Firstly, the content of a document input by the document input unit 101 is extracted as stroke information (step S501), thereby performing overall area determination (step S502). In the overall area determination, areas (segments) including strokes are detected in the entire page, and it is roughly detected whether each segment includes a character string. While doing this, the target area is gradually enlarged in each page, thereby discriminating the segments including character strings from the segments including no character strings (these segments are assumed to be figure areas) (step S503). At step S504, it is determined whether a figure area exists. If a figure area exists, the program proceeds to step S505, whereas if no figure area exists, the program proceeds to step S506.

If a figure area exists, corresponding figures, if any, are extracted from the figure area, referring to beforehand input figure feature information associated with line intersections, presence/non-presence of a closed path, etc., and also referring to beforehand defined models (step S505). In contract, if no figure area exists, or after step S505, it is determined whether a text area exists. If a text area exists, the program proceeds to step S507, whereas if no text area exists, the program proceeds to step S508 (step S506).

If a text area exists, character recognition processing is performed on the text area (step S507). In handwriting character recognition processing, a character string of a highest likelihood, resulting from a comparison between a stroke feature amount and a character recognition model, is output as a recognition result. If no text area exists, this processing is skipped.

Lastly, the extracted basic figure and the text information are stored in association with the input document (page information), thereby completing the processing (step S508). The text information is information comprising only a character string.

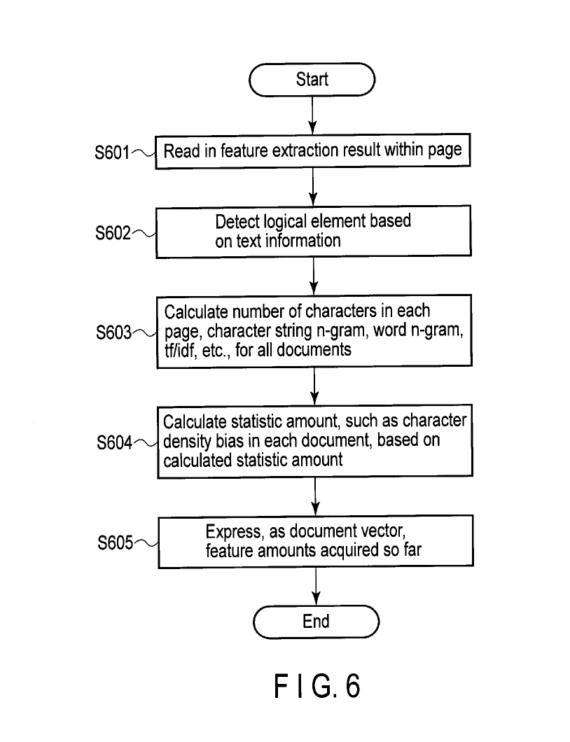

Referring then to FIG. 6, a description will be given of an operation example of the document feature amount extracting/converting unit 103.

Firstly, the feature extraction result of a document (page) obtained as the result of the processing up to the processing by the figure feature extracting unit 102 is read (step S601).

Based on the text information, a logical element and position information on a stroke are detected (step S602). The logical element, here, is attribute information obtained by mainly using a row as granularity, and means, from the relationship between adjacent rows, a title or a sub-title, an element of a list, and also means, from their combinations, an attribute such as a hierarchical structure comprising a plurality of stages, such as a chapter, a section, and a sub section.

There are some methods for detecting the logical element. A description will now be given of an example method of detecting a title or the logical element of a paragraph by determining the similarity or independency of adjacent rows based on character strings, utilizing the handwriting recognition result.

Firstly, a title description is specified. To this end, the average number and variance of character strings of each row included in a page are beforehand calculated, and an appropriate threshold for a title row is heuristically set beforehand. Further, whether an empty row appears as the row immediately before a title or as the row immediately before the first-mentioned row may be used as a condition for a weighting coefficient for determination. Subsequently, the relationship between rows regarded as title rows is detected. More specifically, if the character string at the beginning portion of the title row comprises symbols or numbers, it is detected whether these elements are similar to each other.

It is hereinafter assumed that the elements of a set comprise the beginning symbols of respective rows determined title rows (examples: rows beginning with bullets ({, }) are completely identical between different pages→degree of similarity=“high”); the beginning symbols of respective rows are identical in two of three symbols {(1), (2), (3)} between pages→degree of similarity=“middle”); none of the beginning symbols ({(1), [A]}) of respective rows are identical between pages→“no similarity”).

To determine the degrees of similarity, there is a method using simple character string distances, in which, for example, the “high,” “middle” and “low” levels of similarity are heuristically determined based on the rate of concordance. Further, when numerical values appear in a comparative target character string, if the numerical values are increasing from the beginning of a page, a correction value indicating a high degree of similarity may be applied (in the case of, for example, {(1), (2), (3)}, the numerical values are considered to be increasing, the degree of similarity is not set to “middle,” but to “high.”).

Title detection is performed as mentioned above, and the distance between titles (how far the titles are separate from each other) is detected. If the distance is not more than 2 rows, the titles are the text elements between the titles are stored as an itemization list. Further, if the distance is not less than 3 rows, the text elements are stored as titles for a chapter structure, and each row between the titles are stored as regions indicating paragraphs. The above processing enables detection and assignment of the title, paragraph or itemization associated with the logical element of each row.

Returning to FIG. 6, a feature amount detected using information associated with a plurality of documents (not a single document) is extracted (step S603). More specifically, for all documents (pages), the number of characters per each page is counted, or the character string n-gram, word n-gram, and their tf/idf values are calculated. The feature amount indicates, for example, the number of titles or bullet points.

Based on the whole statistic amount, feature amounts corresponding to individual documents are calculated (step S604). The document feature amount extracting/converting unit 103 newly extracts one or more of the figure information, the annotation information and the text information, based on the statistic amount obtained from a plurality of documents, and calculates a feature amount from the extracted information. The statistic amount is, for example, a bias in character appearance density in each page detected with respect to the average number of characters between pages.

Lastly, the thus-obtained feature amount is expressed as a document vector, thereby terminating the processing (step S605).

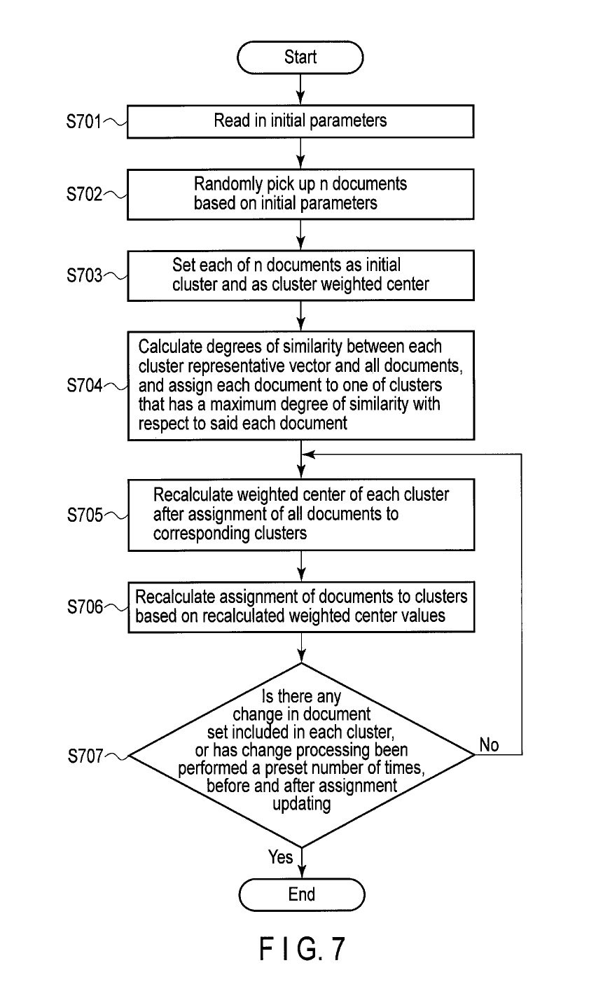

Referring then to FIG. 7, a description will be given of an operation example of the similarity detecting unit 104.

Firstly, initial parameters for similarity detection are read in (step S701). More specifically, an initial cluster number is set, and the maximum number of repetitions of updating processing is set.

Based on the initial parameters, n documents are randomly picked up (step S702). It is assumed that the initial cluster number is set to n.

The n documents are each set as an initial cluster and as a cluster weighted center (step S703).

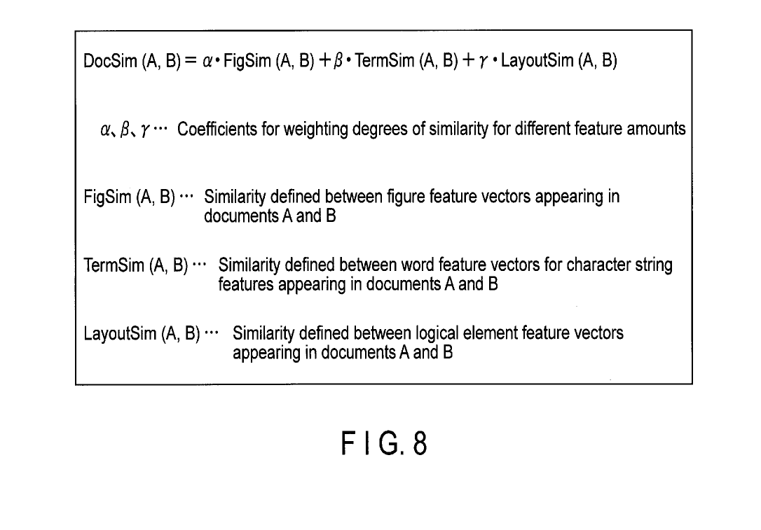

Subsequently, the degrees of similarity between the representative value of each cluster and all documents are calculated, and each document is assigned to the cluster, with which the degree of similarity of said each document is highest (step S704). The representative value of each cluster indicates a representative vector. In the example described later with reference to FIG. 8, there are three types of representative vectors, i.e., a figure feature vector, a word feature vector and a logical element feature vector. In this case, at step S704, degrees of similarity are calculated regarding the three types of representative vectors, and documents are assigned to respective clusters, with which the degrees of similarity of the documents are highest, the clusters having final degrees of similarity obtained by weighting the calculated degrees of similarity with values α, β and γ as in a numerical expression recited later.

After finishing assignment of all documents to the clusters, the weighted center of each cluster is re-calculated (step S705).

Based on the re-calculated cluster weighted center, the degree of similarity between the representative vector of each cluster and the document vector of each document is calculated to thereby re-calculate assignment of documents to clusters (step S706). In the example of FIG. 8, the document vector means the combination of a figure feature vector, a word feature vector and a logical element feature vector. The calculation of the degrees of similarity between the representative vector of each cluster and the document vector of each document means that respective degrees of similarity are calculated using the three types of representative vectors, and a final degree of similarity is obtained by weighting the calculated degrees of similarity with values α, β and γ as in the numerical expression recited later.

After that, it is determined whether there is no change in the set of documents assigned to each cluster, before and after the cluster assignment updating, or whether updating processing is performed a preset number of times (step S707). If it is determined that there is no change in the document set or that the updating processing is performed the preset number of time, the above program is finished. In contrast, if it is determined that there is a change in the document set or that the updating processing is not performed the preset number of time, the program returns to step S705, thereby repeating the calculation of the cluster weighed center and the operation of updating document-to-cluster assignment.

Referring to FIG. 8, a description will be given of the definition of degree of similarity between documents.

Assume here that documents A and B are compared with each other in degree of similarity, that DocSim (A, B) represents the degree of similarity between the documents A and B, and that the right-hand member of the equation shown in FIG. 8 comprises a degree of similarity based on an appearing figure feature, a degree of similarity based on an appearing character string feature, and a degree of similarity based on an appearing logical element feature.

Assume also that before defining the degree of similarity based on the figure feature, the type and size of a basic figure extracted from a certain document should be made to correspond to each other as follows:

An expression example of a base: 0000 (the upper two digits represents the number of figures, the lowermost digit represents figure type ID, and the tens digit represents a size ID)

Basic figure type ID: {◯, , Δ}→{1, 2, 3}

Size definition ID: {within a row, within three rows, within five rows, half page, one page}→=>{1, 2, 3, 4, 5}

Further, to express a figure feature using a vector, the following nine-dimensional vector is defined:

Central position of a figure: {upper left, upper center, upper right, left center, center, right center, lower left, lower center, lower right}

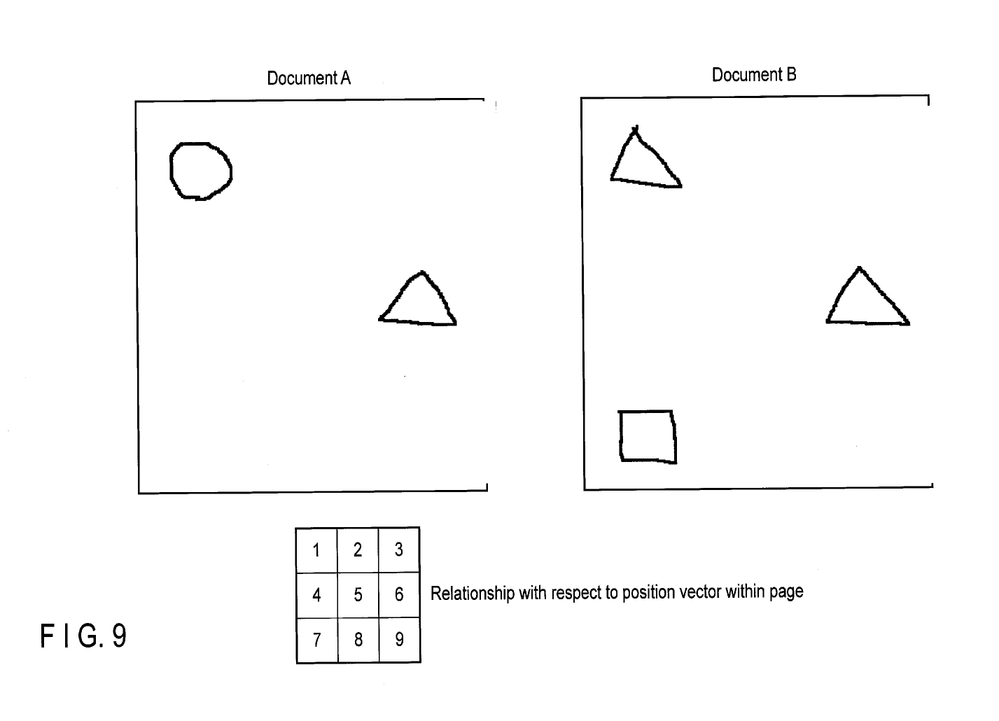

The figure feature vector for each document can be expressed by describing the above base information for the nine-dimensional vector. An explanation will be given of the document examples for defining similarity in figure feature, shown in FIG. 9.

Assuming that in document A, figures ◯ and Δ appear at the upper left position and the middle right position, respectively, the figure feature vector of document A is expressed by

{0121,0,0,0,0,0123,0,0,0}

Similarly, assuming that in document B, figures Δ, Δ and appear at the upper left position, the middle right position, and the lower left position, respectively, the figure feature vector of document B is expressed by

{0123,0,0,0,0,0123,0122,0,0}

FigSim (A, B) represents the degree of similarity defined by the figure feature vectors appearing in documents A and B. Assuming here that FigSim (A, B) represents, for example, the cosine similarity of the feature vectors, it is expressed by

FigSim(A,B)=(0121×0123+0+0+0+0+0123×0123+0×0122+0+0)/(0121²+01232)^{1/2}×(0123²+0123²+0122²)^{1/2}=30012/(17254×212.47)=0.82

Thus, the degree of similarity by FigSim is computed at 0.82.

Similarly, TermSim (A, B) represents the degree of similarity defined between the word feature vectors for character string features, appearing in documents A and B. TermSim (A, B) represents the degree of similarity between documents, using, as feature vectors, words, complex words or character strings n-gram appearing in the documents. More specifically, a description will be given of, for example, TermSim (A, B) between documents A and B. Assume here that a morphological analysis is applied to the text of document A, and that “conference note,” “patent research,” “project” and “idea” are extracted as nouns (complex words) (i.e., the nouns extracted from document A=“conference note,” “patent research,” “project” and “idea”). Similarly, assume that “report,” “project,” “delivery date” and “process management” are extracted from document B (i.e., the nouns extracted from document B=“report,” “project,” “delivery date” and “process management”).

These appeared words can be arranged as a word appearance list, as follows:

Word appearance list={delivery date, report, conference note, patent research, idea, project, process management}

If whether these words appear or not in each document is expressed by a vector “0” (representing that the words do not appear) or “1” (representing that the words appear) along the content of the list, the word feature vector can be expressed as follows:

The word feature vector of document A={0, 0, 1, 1, 1, 1, 0}

The word feature vector of document B={1, 1, 0, 0, 0, 1, 1}

Using these word feature vectors, the degree of similarity between documents can be expressed using, for example, a cosine similarity cos(A, B)=A·B/|A∥B| (“” represents a vector inner product, and ∥ represents an absolute value).

In the above example, the following TermSim (A, B) is obtained:

TermSim(A,B)=(0+0+0+0+0+1+0)/((√4)×(√4))=1/(2×2)=¼=0.25

In this case, the degree of similarity is expressed by a value falling within the range of 0 to 1. Since the value of “1” indicates the most similar (identical), it is understood that the above documents are not so similar to each other.

Further, LayoutSim (A, B) is the degree of similarity defined between logical element feature vectors appearing in documents A and B. This degree of similarity is a result of calculation made when the appearance of logical elements in a document is expressed as a DOM expression (tree structures), the degree of similarity between tree structures being calculated in view of, for example, an editing distance.

Although such a general definition as that for the word feature vector is not established for the degree of similarity between structures, the definition recited below is made as an example. As in the word feature vector, the attribute of a document is defined.

Assume here that there exist the following attribute types:

Definition list of structure information={title, subtitle, body text, paragraph, itemization, annotation, cell}

Assume that in document A, “title” and “subtitle” could be detected by, for example, pre-defined rule matching associated with font size, character string position, text length in one row. Assume also that in document B, “itemization,” and “cell” as a table description, as well as “subtitle,” could be detected from the indent positions of rows vertically adjacent to “subtitle,” or from the degree of coincidence of appearing words/character strings. In this case, documents A and b can be expressed as follows:

The logical element feature vector of document A={1, 1, 0, 0, 0, 0, 0, o}

The logical element feature vector of document B={0, 1, 0, 0, 1, 0, 0, 1}

For these vectors, the degree of similarity defined by the above-mentioned cosine degree of similarity can be computed. More specifically, the degree of similarity between documents A and B can be computed at:

LayoutSim(A,B)=A·B/|A∥B|=(0+1+0+0+0+0+0+0)/√2×√3=1/√6=0.4082 . . . =approx. 0.4.

For each structure information item, it is not necessary to deal with the corresponding logical element (title, subtitle, paragraph) with the same weight. For instance, the weight for, for example, the title or subtitle may be biased to a greater value. Further, instead of detecting whether there exist the same logical elements, the degree of coincidence between text character strings contained in the logical elements may be considered.

In view of the above, it is assumed that the degree of similarity between the entire pages is defined as a combination of the degrees of similarity obtained by applying proper coefficients to initial degrees of similarity. In this example, the degrees of similarity described so far are summed up. The coefficients are provided for respective similarity weights for different feature amounts. For the coefficients, initial fixed values experimentally obtained may be set. Alternatively, the coefficients may be biased in is accordance with the biased amounts of document data features accumulated by a user. Assuming that coefficients α, β and γ are set to default values of ⅓, ⅓ and ⅓, respectively, the values calculated so far are substituted into the following equation:

DocSim(A,B)=α·FigSim(A,B)+βTermSim(A,B)+γ·LayoutSim(A,B)

At this time, the following value can be obtained:

DocSim(A,B)=α·0.82+β·0.25+γ·0.4=⅓×0.82+⅓×0.25+⅓××0.4=0.49

Similarly, the degrees of similarity of the arbitrary two accumulated documents can be calculated. Regarding weighting, the user may prepare adjustable adjusting means.

As described above, the combination of the figure feature vector, the word feature vector and the logical element feature vector corresponds to the document vector. By summing up the values obtained by weighting the figure feature vector, the word feature vector and the logical element feature vector with respective degrees of similarity, the degree of similarity between the two documents is calculated.

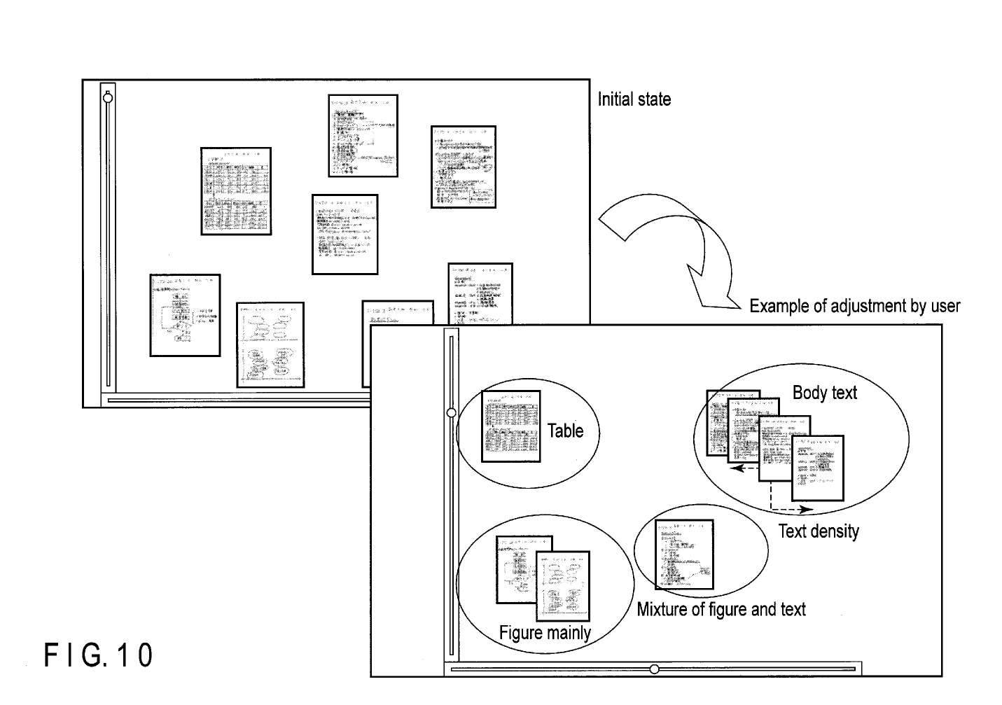

Referring then to FIG. 10, a description will be given of a specific example of the adjusting means. More specifically, a description will be given of an example of an interface for adjusting similarity weighting. FIG. 10 shows a display example of the candidate presenting/selecting unit 201.

Assume here that a classification result at a certain time point is mapped on a two-dimensional plane defined by two axes as shown in the upper left portion, in view of the result of processing performed in a later stage, and that the user can adjust the sliders of the X- and Y-axes. As will be described later, the X- and Y-axes indicate linear coupling of a plurality of elements, and the user can change the weight for coupling by adjusting the sliders, thereby varying the distance between documents (thumbnails) on the plane representing the degree of similarity between the documents, or the distance between document groups. For instance, the X-axis indicates β/α, and the Y-axis indicates γ/α.

When the user has changed weighting by moving the sliders, they can determine the validity of the changed weighting, utilizing the fact, for example, that certain two documents are classified into one group, or they are classified into different groups.

As a result, the weighting updated by the user using the sliders can be reflected in the weight of each element used by the system for calculating the degree of similarity between documents.

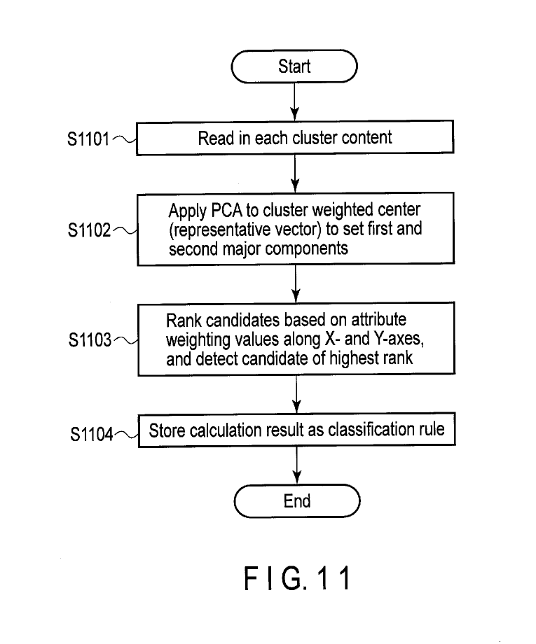

Referring then to FIG. 11, an operation example of the candidate calculating unit 105 will be described.

Firstly, each cluster information is read in (step S1101). Namely, the representative vector of each cluster is read in.

The weighted center (corresponding to the representative vector) of each cluster is subjected to principle component analysis (PCA), thereby setting a first major component and a second major component (corresponding to the X- and Y-axes) (step S1102).

Based on the weights for the attributes corresponding to the X- and Y-axes, candidates are ranked to determine a candidate of the highest rank (step S1103).

The calculation result is stored as a classification rule in the classification rule storage 106 (step S1104).

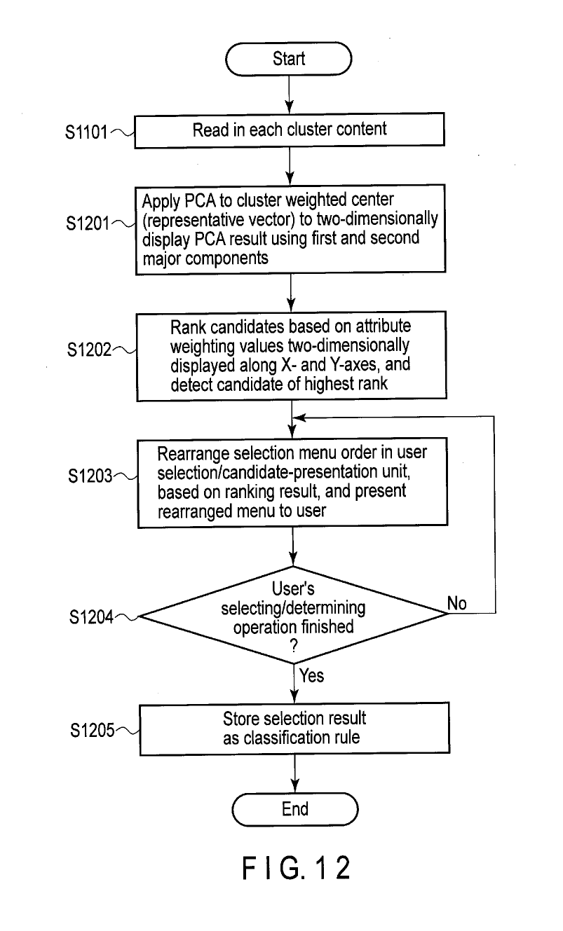

Referring to FIG. 12, a description will be given of an example of an operation performed to present candidates to the user, i.e., an operation example of the candidate presenting/selecting unit 201.

Firstly, each cluster information is read in (step S1101).

The weighted center (corresponding to the representative vector) of each cluster is subjected to PCA, thereby performing two-dimensional display using a first major component and a second major component (step S1202).

Based on the weights for the two-dimensionally displayed attributes providing the X- and Y-axes, presented candidates are ranked (step S1203).

Subsequently, based on the ranking result, the selection menu components of the candidate presenting/selecting unit 201 are rearranged and presented to the user (step S1204).

If the user finishes selection/determination operation of each rule based on the presentation result, the selection result is stored as a classification rule (step S1205). If the user does not finish the operation, menu presentation and selection operation are repeated.

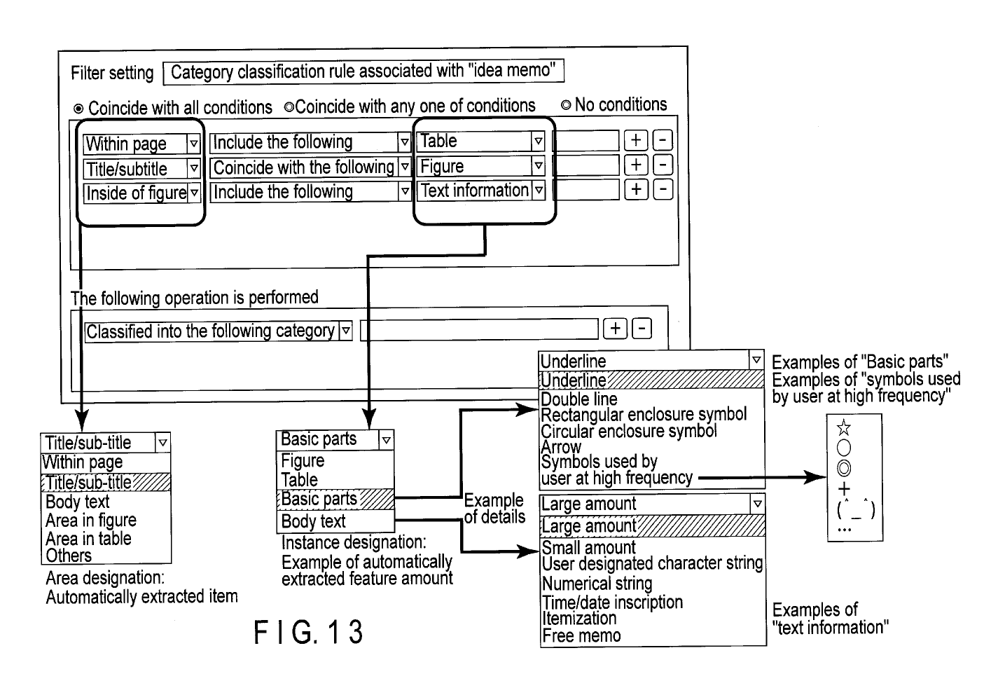

Referring now to FIG. 13, a description will be given of an example of a classification candidate presentation display in the candidate presenting/selecting unit 201.

In this embodiment, it is an object to construct a user's desired detailed classification rule, by user's customizing an IF-THEN format rule.

The user can select a candidate from a plurality of conditions, or define a condition. Further, the user can combine conditions by designating that each condition should coincide with all conditions (AND), or coincide with any one of the conditions (OR).

Each condition is defined using an arbitrary character string input by the user, such as, “area designation,” “instance designation,” or “detailed example (detailed attribute).” It is assumed that the range indicated by the “area designation” can be limited by a constraint condition, such as a condition that the range is included in the designated area, a condition that the range is excluded from the designated area, or a condition that the range must coincide with the designated area. In the “area designation,” document attributes, such as inside/outside of the body of a page, inside of text, upper/middle/lower portions of a page, can be defined as the output attributes of the figure feature extracting unit 102 and the document feature amount extracting/converting unit 103, as well as titles, subtitles, inside of a figure, inside of a table. In the “instance designation,” text character strings are designated, as well as figures, tables, basic parts, etc., automatically extracted from the accumulated documents. Depending upon the content of the accumulated documents, different candidates are presented. As a result, meaningful appropriate attributes corresponding to a target document and useful in constructing a classification rule are displayed.

Each instance in the “instance designation” may define more detailed attributes. For instance, in the case of a figure, a circle, a rectangle, a triangle, etc., may be defined. In the case of a table, its scale may be defined (rough designation of “large” or “small,” or detailed designation of a row or a column, or of the range of rows or columns). In the case of text information, a time and date, a numerical string, unique names, such as person names, organization names, etc., can be defined, based on a character string itself designated by a user, the number of the characters, and the morphological analysis result of text.

Yet further, in the case of the basic parts, if there are symbols or character strings (star marks or any other marks unique to the user), as well as underlines, double lines, rectangular or circular enclosure symbols, arrows, etc., they may be presented.

By combining conditions using the above-mentioned candidates, the user can construct a detailed classification rule.

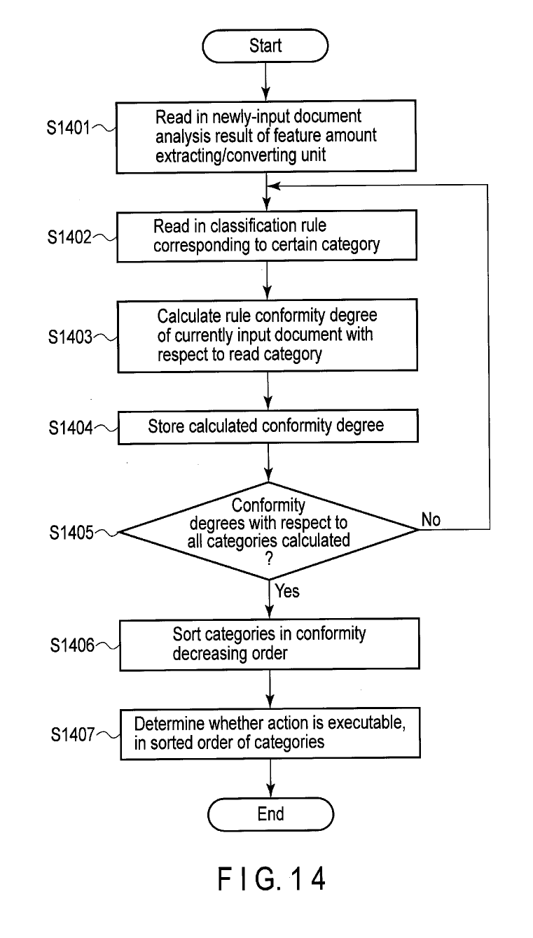

Referring to FIG. 14, a description will be given of an operation example of the classification estimating unit 107.

Firstly, the new input document analysis result of the document feature amount extracting/converting unit 103 is read in (step S1401).

A classification rule corresponding to a certain category is read in (step S1402).

Regarding a currently input document, the degree of rule conformity with respect to the read category is calculated (step S1403). At this step, various calculation methods can be employed. For instance, scores corresponding to the respective rules may be defined beforehand, and the score matching the read rule be added. For example, the following rule is included in the rule definitions classified into the “conference note” category:

(1) The “title” includes a character string of “conference note”→Score=0.8

(2) The “document element” includes “itemization”→Score=0.4

(3) The “body text” includes “TODO”→Score=0.6 If the current input document matches (1) and (3), the score of this document indicating that the document belongs to the “conference note” category is the sum of (1) and (3), i.e., 0.8+0.6=1.4.

Returning to the flowchart of FIG. 14, the calculated rule conformity degree is stored (step S1404).

Subsequently, it is determined whether the degrees of conformity with respect to all categories are already calculated (step S1405). If there is a category that is not processed, the program returns to step S1402, where read-in of the unprocessed categories is iterated.

After conformity degree calculation of all categories is finished, the categories are sorted in conformity decreasing order (step S1406).

In the sorted category order, it is detected whether the action associated with each category can be executed. If the action is executable, it is executed (step S1407). The “action” corresponds to the “operation” included in an expression “next operation is executed” used in FIG. 13, and means the operation finally executed by a classification rule that satisfies the conditions. For instance, it means the operation of storing an input document into a particular folder, imparting a particular classification label as a property of the document, etc.

In the document classification assisting apparatus, method and program described above, a handwritten document input through the tablet can be automatically classified not only in accordance with classification categories unique to the system, but also in accordance with user's document variations. Furthermore, updating and addition of a category can be performed. Also, since the user can freely select and combine, as a filtering rule, the condition candidates presented by the system, the user can easily know the criterion for classification and the content of each category. In addition, since a rule base of an IF-THEN format is combined with a clustering base, classification along a user's intension can be realized from the initial state such as start of use.

Further, in the document classification assisting apparatus, method and program described above, a plurality of items for classification are automatically presented to the user by extracting, from a document set selected by the user, statistic values associated with presence/non-presence of a figure or table, annotation symbol variations, such as double lines and enclosures, character strings or words appearing, layouts (logical elements), and clustering the extracted values. As a result, the user can combine the presented classification items to freely create a classification rule.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document classification assisting apparatus comprising:
a document input unit configured to input a plurality of documents including stroke information;
an extracting unit configured to extract, from the stroke information, at least one of figure information, annotation information and text information;
a feature amount calculator configured to calculate, from the information extracted, feature amounts that enable comparison in similarity between the documents;
a setting unit configured to set a plurality of clusters including representative vectors that indicate features of the clusters and each include the feature amounts, and to detect to which one of the clusters each of the documents belongs;
a calculator configured to calculate, as a classification rule, at least one of the feature amounts included in the representative vectors and characterizing the representative vectors; and
a storage configured to store the classification rule.

2. The apparatus according to claim 1, wherein the calculator comprises:
a presentation unit configured to present the at least one of the feature amounts to a user; and
a selector configured to enable the user to select and set the at least one of the feature amounts as the classification rule.

3. The apparatus according to claim 2, wherein the presentation unit presents, as a distance between the documents and a distance between document groups each including at least one of the documents, at least one degree of similarity between the documents and between the document groups respectively, the presentation unit enabling the user to adjust the distance.

4. The apparatus according to claim 1, wherein the document input unit inputs a first document, and the feature amount calculator calculates a first feature amount from the first document,
further comprising a comparing unit configured to compare the first feature amount with the classification rule to estimate at least one category that has a higher degree of conformity with the first feature amount.

5. The apparatus according to claim 4, wherein if an action is associated with the estimated category, the comparing unit detects whether the action is executable, and executes the action if the action is executable.

6. The apparatus according to claim 1, wherein the feature amounts are represented by vectors.

7. The apparatus according to claim 1, wherein the feature amount calculator newly extracts at least one of the feature information, the annotation information and the text information in accordance with a statistic amount acquired from the documents, and calculates the feature amounts from the newly extracted information.

8. A document classification assisting method comprising:
acquiring a plurality of documents including stroke information;
extracting, from the stroke information, at least one of figure information, annotation information and text information;
calculating, from the information extracted, feature amounts that enable comparison in similarity between the documents;
setting a plurality of clusters including representative vectors that indicate features of the clusters and each include the feature amounts, and detecting to which one of the clusters each of the documents belongs;
calculating, as a classification rule, at least one of the feature amounts included in the representative vectors and characterizing the representative vectors; and
storing the classification rule.

9. A computer readable medium including computer executable instructions for assisting document classification, wherein the instructions, when executed by a processor, cause the processor to perform a method comprising:
acquiring a plurality of documents including stroke information;
extracting, from the stroke information, at least one of figure information, annotation information and text information;
calculating, from the information extracted, feature amounts that enable comparison in similarity between the documents;
setting a plurality of clusters including representative vectors that indicate features of the clusters and each include the feature amounts, and detecting to which one of the clusters each of the documents belongs;
calculating, as a classification rule, at least one of the feature amounts included in the representative vectors and characterizing the representative vectors; and
storing the classification rule.
